(19) United States
(12) Patent Application Publication
(10) Pub. No.: US 2025/0151029 A1
(43) Pub. Date: May 8, 2025

(54) METHODS AND APPARATUSES OF RESOURCE SELECTION FOR SIDELINK COMMUNICATION

(71) Applicant: LENOVO (BEIJING) LIMITED, Beijing (CN)

(72) Inventors: Xin GUO, Beijing (CN); Haipeng LEI, Beijing (CN); Zhennian SUN, Beijing (CN); Xiaodong YU, Beijing (CN)

(21) Appl. No.: 18/832,798

(22) PCT Filed: Jan. 25, 2022
(86) PCT No.: PCT/CN2022/073828

§ 371 Date: Jul. 24, 2024

(51) Int. Cl. H04W 72/02; H04W 72/0446

(52) U.S. Cl. CPC H04W 72/02; H04W 72/0446

(57) ABSTRACT

Embodiments of the present disclosure relate to methods and apparatuses of resource selection for sidelink (SL) communication. According to an embodiment of the present disclosure, a user equipment (UE) can include: a processor configured to: obtain a position characteristic configuration associated with a resource pool based on configuration or pre-configuration, wherein the position characteristic configuration includes a set of position characteristics, and each position characteristic indicates an availability level of a position in an SL slot for simultaneous sub-slot level transmission and slot level transmission; and perform a sensing-based resource selection or re-selection based at least in part on the position characteristic configuration; a transmitter coupled to the processor; and a receiver coupled to the processor.

### TECHNICAL FIELD

Embodiments of the present application are related to wireless communication technology, and more particularly, related to methods and apparatuses of resource selection for sidelink (SL) communication.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability and to reduce latency and power consumption. With the development of 3GPP 5G networks, various aspects need to be studied and developed to perfect the 5G technology. Currently, details regarding resource selection for sidelink communication need to be further discussed in 3GPP 5G technology.

### SUMMARY OF THE APPLICATION

Embodiments of the present application at least provide a technical solution of resource selection for sidelink communication.

According to some embodiments of the present application, a UE may include: a processor configured to: obtain a position characteristic configuration associated with a resource pool based on configuration or pre-configuration, wherein the position characteristic configuration includes a set of position characteristics, and each position characteristic indicates an availability level of a position in an SL slot for simultaneous sub-slot level transmission and slot level transmission; and perform a sensing-based resource selection or re-selection based at least in part on the position characteristic configuration; a transmitter coupled to the processor; and a receiver coupled to the processor.

In some embodiments of the present application, the position characteristic configuration is configured or pre-configured along with a slot pattern configuration or a sub-slot pattern configuration per resource pool.

In some embodiments of the present application, the position is represented by a symbol within the SL slot or a sub-slot within the SL slot.

In some embodiments of the present application, the availability level of the position is indicated as one of the following: an available position (AP) which means that the position is available for sub-slot level transmission without affecting a slot level transmission in the SL slot; or a non-available position (NAP) which means that the position is not available for sub-slot level transmission without affecting a slot level transmission in the SL slot.

In some embodiments of the present application, the availability level of the position is indicated as one of a plurality of integers.

In some embodiments of the present application, the processor is further configured to determine a resource reservation pattern of a slot level candidate resource including a plurality of pattern blocks (PBs), and wherein each PB occupies one sub-slot of the slot level candidate resource and one sub-channel of the slot level candidate resource.

In some embodiments of the present application, the resource reservation pattern includes a plurality of sets of information associated with the plurality of PBs, wherein each set of information is associated with a PB of the plurality of PBs and includes at least one of: a reference signal received power (RSRP) value associated with the PB, which is determined based on measurement(s) on resource(s) associated with reserved resource(s) containing the PB for sub-slot level transmission; or a priority associated with an intended sub-slot level transmission on the reserved resource(s) containing the PB for sub-slot level transmission.

In some embodiments of the present application, the processor is further configured to obtain configuration information for the resource reservation pattern, and wherein the configuration information includes at least one of: a principle for calculating an available weight (AW) value for each PB of the slot level candidate resource; or an AW threshold for each PB of the slot level candidate resource.

In some embodiments of the present application, the principle indicates that the AW value for each PB is calculated based on at least one of: a position characteristic of the PB which is determined based on position characteristic(s) of position(s) in the PB; an RSRP value associated with the PB; or a priority associated with the PB.

In some embodiments of the present application, to perform the sensing-based resource selection or re-selection, the processor is configured to select at least one slot level candidate resource in a selection window (SW).

In some embodiments of the present application, the at least one slot level candidate resource is selected based on at least one of the following principles: prioritizing slot level candidate resource(s) including resource(s) reserved for sub-slot level transmission(s) on available position(s); prioritizing slot level candidate resource(s) including resource(s) reserved for sub-slot level transmission(s) associated with lower RSRP value(s); or prioritizing slot level candidate resource(s) including resource(s) reserved for sub-slot level transmission(s) associated with lower priority level(s).

In some embodiments of the present application, the at least one slot level candidate resource is selected based on one of the following principles: selecting slot level candidate resource(s) with AW value(s) higher than an AW threshold for the slot level candidate resource(s); selecting slot level candidate resource(s) with AW value(s) lower than the AW threshold for the slot level candidate resource(s); selecting slot level candidate resource(s) according to an increasing order of AW values for all slot level candidate resources determined in the SW; or selecting slot level candidate resource(s) according to a decreasing order of AW values for all slot level candidate resources determined in the SW.

In some embodiments of the present application, an AW value for a slot level candidate resource is a sum of AW values for all PBs within the slot level candidate resource, and the AW threshold for the slot level candidate resource(s) equals an AW threshold for each PB multiplied by a number of PBs within each slot level candidate resource.

According to some embodiments of the present application, a BS may include: a transmitter configured to: transmit a position characteristic configuration associated with a resource pool, wherein the position characteristic configuration includes a set of position characteristics, and each position characteristic indicates an availability level of a position in an SL slot for simultaneous sub-slot level transmission and slot level transmission; a processor coupled to the transmitter; and a receiver coupled to the processor.

In some embodiments of the present application, the position characteristic configuration is transmitted along with a slot pattern configuration or a sub-slot pattern configuration per resource pool.

In some embodiments of the present application, the position is represented by a symbol within the SL slot or a sub-slot within the SL slot.

In some embodiments of the present application, the availability level of the position is indicated as one of the following: an AP which means that the position is available for sub-slot level transmission without affecting a slot level transmission in the SL slot; or a NAP which means that the position is not available for sub-slot level transmission without affecting a slot level transmission in the SL slot.

In some embodiments of the present application, the availability level of the position is indicated as one of a plurality of integers.

In some embodiments of the present application, the transmitter is further configured to transmit configuration information for a resource reservation pattern of a slot level candidate resource including a plurality of PBs, wherein each PB occupies one sub-slot of the slot level candidate resource and one sub-channel of the slot level candidate resource, and wherein the configuration information includes at least one of: a principle for calculating an AW value for each PB of the slot level candidate resource; or an AW threshold for each PB of the slot level candidate resource.

In some embodiments of the present application, the principle indicates that the AW value for each PB is calculated based on at least one of: a position characteristic of the PB which is determined based on position characteristic(s) of position(s) in the PB; an RSRP value associated with the PB; or a priority associated with the PB.

According to some embodiments of the present application, a method performed by a UE may include: obtaining a position characteristic configuration associated with a resource pool based on configuration or pre-configuration, wherein the position characteristic configuration includes a set of position characteristics, and each position characteristic indicates an availability level of a position in an SL slot for simultaneous sub-slot level transmission and slot level transmission; and performing a sensing-based resource selection or re-selection based at least in part on the position characteristic configuration.

In some embodiments of the present application, the position characteristic configuration is configured or pre-configured along with a slot pattern configuration or a sub-slot pattern configuration per resource pool.

In some embodiments of the present application, the position is represented by a symbol within the SL slot or a sub-slot within the SL slot.

In some embodiments of the present application, the availability level of the position is indicated as one of the following: an AP which means that the position is available for sub-slot level transmission without affecting a slot level transmission in the SL slot; or a NAP which means that the position is not available for sub-slot level transmission without affecting a slot level transmission in the SL slot.

In some embodiments of the present application, the availability level of the position is indicated as one of a plurality of integers.

In some embodiments of the present application, the method may further include: determining a resource reservation pattern of a slot level candidate resource including a plurality of PBs, wherein each PB occupies one sub-slot of the slot level candidate resource and one sub-channel of the slot level candidate resource.

In some embodiments of the present application, the resource reservation pattern includes a plurality of sets of information associated with the plurality of PBs, wherein each set of information is associated with a PB of the plurality of PBs and includes at least one of: an RSRP value associated with the PB, which is determined based on measurement(s) on resource(s) associated with reserved resource(s) containing the PB for sub-slot level transmission; or a priority associated with an intended sub-slot level transmission on the reserved resource(s) containing the PB for sub-slot level transmission.

In some embodiments of the present application, the method may further include: obtaining configuration information for the resource reservation pattern, wherein the configuration information includes at least one of: a principle for calculating an AW value for each PB of the slot level candidate resource; or an AW threshold for each PB of the slot level candidate resource.

In some embodiments of the present application, the principle indicates that the AW value for each PB is calculated based on at least one of: a position characteristic of the PB which is determined based on position characteristic(s) of position(s) in the PB; an RSRP value associated with the PB; or a priority associated with the PB.

In some embodiments of the present application, performing the sensing-based resource selection or re-selection includes selecting at least one slot level candidate resource in an SW.

In some embodiments of the present application, the at least one slot level candidate resource is selected based on at least one of the following principles: prioritizing slot level candidate resource(s) including resource(s) reserved for sub-slot level transmission(s) on available position(s); prioritizing slot level candidate resource(s) including resource(s) reserved for sub-slot level transmission(s) associated with lower RSRP value(s); or prioritizing slot level candidate resource(s) including resource(s) reserved for sub-slot level transmission(s) associated with lower priority level(s).

In some embodiments of the present application, the at least one slot level candidate resource is selected based on one of the following principles: selecting slot level candidate resource(s) with AW value(s) higher than an AW threshold for the slot level candidate resource(s); selecting slot level candidate resource(s) with AW value(s) lower than the AW threshold for the slot level candidate resource(s); selecting slot level candidate resource(s) according to an increasing order of AW values for all slot level candidate resources determined in the SW; or selecting slot level candidate resource(s) according to a decreasing order of AW values for all slot level candidate resources determined in the SW.

In some embodiments of the present application, an AW value for a slot level candidate resource is a sum of AW values for all PBs within the slot level candidate resource, and the AW threshold for the slot level candidate resource(s) equals an AW threshold for each PB multiplied by a number of PBs within each slot level candidate resource.

According to some embodiments of the present application, a method performed by a BS may include: transmitting a position characteristic configuration associated with a resource pool, wherein the position characteristic configuration includes a set of position characteristics, and each position characteristic indicates an availability level of a position in an SL slot for simultaneous sub-slot level transmission and slot level transmission.

In some embodiments of the present application, the position characteristic configuration is transmitted along with a slot pattern configuration or a sub-slot pattern configuration per resource pool.

In some embodiments of the present application, the position is represented by a symbol within the SL slot or a sub-slot within the SL slot.

In some embodiments of the present application, the availability level of the position is indicated as one of the following: an AP which means that the position is available for sub-slot level transmission without affecting a slot level transmission in the SL slot; or a NAP which means that the position is not available for sub-slot level transmission without affecting a slot level transmission in the SL slot.

In some embodiments of the present application, the availability level of the position is indicated as one of a plurality of integers.

In some embodiments of the present application, the method may further include: transmitting configuration information for a resource reservation pattern of a slot level candidate resource including a plurality of PBs, wherein each PB occupies one sub-slot of the slot level candidate resource and one sub-channel of the slot level candidate resource, and wherein the configuration information includes at least one of: a principle for calculating an AW value for each PB of the slot level candidate resource; or an AW threshold for each PB of the slot level candidate resource.

In some embodiments of the present application, the principle indicates that the AW value for each PB is calculated based on at least one of: a position characteristic of the PB which is determined based on position characteristic(s) of position(s) in the PB; an RSRP value associated with the PB; or a priority associated with the PB.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates two exemplary sidelink slot patterns according to some embodiments of the present application;

FIG. 3 illustrates an exemplary sidelink sub-slot pattern according to some embodiments of the present application;

FIG. 4 illustrates another exemplary sidelink sub-slot pattern according to some other embodiments of the present application;

FIG. 5 illustrates a flowchart of an exemplary method for resource selection according to some embodiments of the present application;

FIG. 6 illustrates an exemplary resource reservation pattern for a slot level candidate resource according to some embodiments of the present application; and

FIG. 7 illustrates a simplified block diagram of an exemplary apparatus for resource selection according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

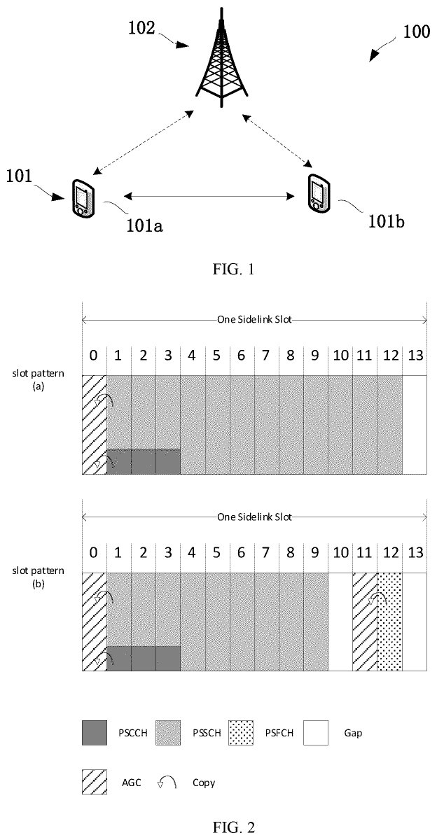

FIG. 1 illustrates an exemplary wireless communication system 100 in accordance with some embodiments of the present application.

As shown in FIG. 1, the wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface. Moreover, UE(s) 101 may work in a wider Internet-of-Thing (IoT) or Industrial IoT (IIoT) scenario with increased demand(s) of low air-interface latency and/or high reliability to be addressed, which includes such as factory automation, electrical power distribution, and/or transport industry.

In some embodiments of the present application, each of UE(s) 101 may be deployed an IoT application, an enhanced mobile broadband (eMBB) application and/or an ultra-reliable and low latency communications (URLLC) application. For instance, UE 101a may implement an IoT application and may be named as an IoT UE, while UE 101b may implement an eMBB application and/or a URLLC application and may be named as an eMBB UE, a URLLC UE, or an eMBB/URLLC UE. It is contemplated that the specific type of application(s) deployed in UE(s) 101 may be varied and not limited.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

In general, supporting for an NR SL is firstly introduced in 3GPP Rel-16. A slot in which a sidelink communication may be performed can be referred to as a sidelink slot. Although a resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication. Without loss of generality, this application only illustrates examples where all 14 OFDM symbols within a sidelink slot are available for sidelink communication. As per NR sidelink slot specified in 3GPP Rel-16, the first symbol of the available OFDM symbols for sidelink communication of a sidelink slot is a copy of the second symbol of the available OFDM symbols for sidelink communication of the sidelink slot; and the first symbol of the available OFDM symbols for sidelink communication is used for an automatic gain control (AGC) purpose. The operation of AGC is performed by a UE when receiving a signal to determine a amplification degree, and thus, the UE can adjust the gain of a receiver amplifier to fit the power of the received signal. The specific examples of a sidelink slot are shown in FIG. 2, which are described as below.

FIG. 2 illustrates two exemplary sidelink slot patterns (or formats) according to some embodiments of the present application. As shown in FIG. 2, the two exemplary sidelink slot patterns may be referred to as slot pattern (a) and slot pattern (b). In the slot pattern (a) and slot pattern (b), one sidelink slot includes 14 OFDM symbols in total, i.e., OFDM symbol #0 to OFDM symbol #13. OFDM symbol #0 is used for AGC by repeating the first OFDM symbol (i.e., OFDM symbol #1) carrying physical sidelink shared channel (PSSCH) and/or physical sidelink control channel (PSCCH) transmissions. The last available OFDM symbol, i.e., OFDM symbol #13, is always used as a guard symbol (i.e., a gap). In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol”, “a PSSCH and/or PSCCH symbol”, or the like.

In the embodiments of FIG. 2, the difference between slot pattern (a) and slot pattern (b) lies in OFDM Symbol #10 to OFDM symbol #12. Specifically, in slot pattern (a), OFDM Symbol #10 to OFDM symbol #12 are used to carry PSSCH transmissions. However, in slot pattern (b), the hybrid automatic repeat request (HARQ) feedback is enabled for the sidelink slot, and then a physical sidelink feedback channel (PSFCH) transmission is transmitted in the second last available OFDM symbol (i.e., OFDM symbol #12 as shown in slot pattern (b) in FIG. 2) of the sidelink slot. An OFDM symbol carrying a PSFCH transmission may be named as “a PSFCH OFDM symbol”, “a PSFCH symbol”, or the like. One OFDM symbol right prior to the PSFCH symbol may be used for AGC and may include a copy of the PSFCH symbol. For example, OFDM symbol #11 as shown in slot pattern (b) in FIG. 2 is used for AGC by repeating the PSFCH symbol #12 as shown in slot pattern (b) in FIG. 2.

In some embodiments, a guard symbol (i.e., OFDM symbol #10 as shown in slot pattern (b) in FIG. 2) between the PSSCH and/or PSCCH symbol and the PSFCH symbol is needed to provide switching time between “a PSSCH and/or PSCCH transmission/reception” and “a PSFCH transmission”. This implies that, if PSFCH resources are configured for a sidelink slot, this will use a total of three OFDM symbols, including the AGC symbol and the extra guard symbol.

The sidelink slot patterns shown in FIG. 2 are provided for purpose of illustration. It is contemplated that other sidelink slot patterns may be applied.

Considering that the AGC setting time occupies only 15 microseconds (i.e., μsec or μs), and the assumption for the necessary transmission/reception (Tx/Rx) switching gap is 13 μsec while the symbol duration for 15 kHz subcarrier spacing (SCS) is equal to 66.67 μsec and the symbol duration for 30 kHz SCS is equal to 33.33 μsec, it is inefficient to use a whole symbol working as AGC for some SCS, such as, 15 kHz or 30 kHz.

Currently, in emerging latency critical applications (e.g., a factory automation scenario), lower latency requirements are needed and thus cannot be satisfied by a slot-based sidelink transmission. For example, if SCSs are configured per resource pool and if a desired resource pool is configured with a shorter SCS (such as, 15 kHz or 30 kHz), it is required to reduce the transmission latency for the configured SCS. This implies that the latency on the resource pool cannot be reduced by applying a longer SCS. Therefore, sub-slot based sidelink slot pattern (or format) is introduced in supporting low latency and high spectrum efficiency sidelink transmission, which includes the following components such as full-symbol (FS), half-symbol (HS), and combined-symbol (CS).

For instance, the following three types of FS are defined.
(1) FS1 is defined as an FS which is for carrying PSSCH and/or PSCCH transmissions.
(2) FS2 is defined as an FS which is for carrying a PSSCH transmission.
(3) FS3 is defined as an FS which is for carrying a PSFCH transmission.

For instance, the following four types of HS are defined.
(1) HS₁ is defined as an HS which is “a copy of the first half of the nearest PSSCH and/or PSCCH symbol after the HS” or “a copy of the first half of the nearest PSFCH symbol after the HS”. For example, HS₁ can be used for AGC.
(2) HS₂ is defined as an HS which works as a gap for Tx/Rx switching.
(3) HS₃ is defined as an HS which is “a copy of the second half of the nearest PSSCH and/or PSCCH symbol before the HS” or “a copy of the second half of the nearest PSFCH symbol before the HS”. For example, HS₃ can be used for reliability improvement.
(4) HS₄ is defined as an HS carrying extra information by transmitting a preamble sequence. The information carried in HS₄ can be used for supporting a sub-slot based transmission. For example, HS₄ can be used for increasing spectrum efficiency. Or, HS₄ can be used for padding a symbol.

For instance, the following four types of CS are defined.
(1) CS₁ is defined as including two half-symbols, in which the first half of the combined-symbol is HS₁, and the second half of the combined-symbol is HS₄.
(2) CS₂ is defined as including two half-symbols, in which the first half of the combined-symbol is HS₃, and the second half of the combined-symbol is HS₂.
(3) CS₃ is defined as including two half-symbols, in which the first half of the combined-symbol is HS₂, and the second half of the combined-symbol is HS₁.
(4) CS₄ is defined as including two half-symbols, in which the first half of the combined-symbol is HS₄, and the second half of the combined-symbol is HS₂.

Currently, for instance, the following two types of sidelink sub-slots are defined.
(1) Sub-slot type SS_{A} does not include symbol(s) of a PSFCH transmission. That is, SS_{A} includes only “PSSCH and/or PSCCH transmissions” or only “a PSSCH transmission”. Sub-slot type SS_{A} can be further classified as follows:
   a) Sub-slot type SS_{A1} includes one CS₁, at least one FS₁, and one CS₂.
   b) Sub-slot type SS_{A2} includes one CS₁, at least one FS₁, and one HS₂.
   c) Sub-slot type SS_{A3} includes one HS₁, at least one FS₁, and one CS₂.
   d) Sub-slot type SS_{A4} includes one HS₁, at least one FS₁, and one HS₂.
(2) Sub-slot type SS_{B} does not include symbol(s) of PSSCH and/or PSCCH transmissions. That is, SS_{B} includes only a PSFCH transmission. Sub-slot type SS_{B} can be further classified as follows:
   a) Sub-slot type SS_{B1} includes one HS₁, at least one FS₃, and one CS₂.
   b) Sub-slot type SS_{B2} includes one HS₁, at least one FS₃, and one CS₄.
   c) Sub-slot type SS_{B3} includes one HS₁, at least one FS₃, and one HS₂.

FIG. 3 illustrates an exemplary sidelink sub-slot pattern according to some embodiments of the present application. In the embodiments of FIG. 3, one sidelink slot includes 14 OFDM symbols in total, i.e., OFDM symbol #0 to OFDM symbol #13.

According to the embodiments of FIG. 3, the sidelink slot as illustrated by FIG. 3 includes five sidelink sub-slots in total, i.e., SS #0, SS #1, SS #2, SS #3, and SS #4. All of SS #0, SS #1, and SS #2 belong to sub-slot type SS_{A1}, which includes one CS₁, one FS₁ and one CS₂. SS #3 belongs to sub-slot type SS_{A2}, which includes one CS₁, one FS₁ and one HS₂. SS #4 belongs to sub-slot type SS_{B1}, which includes one HS₁, one FS₃ and one CS₂.

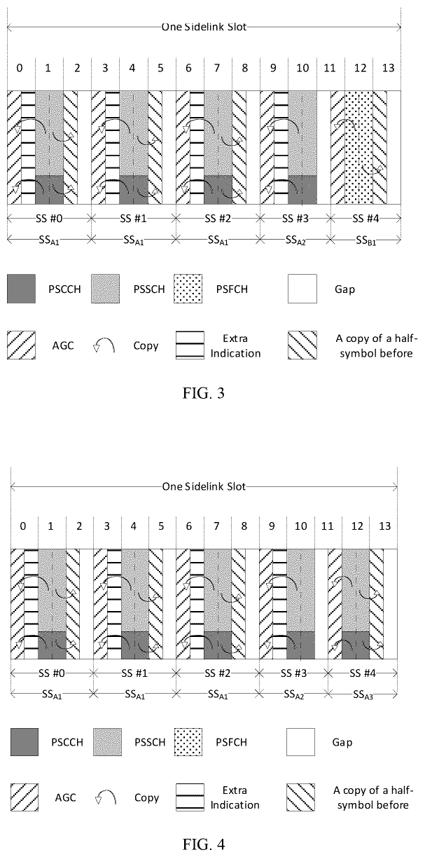

FIG. 4 illustrates another exemplary sidelink sub-slot pattern according to some other embodiments of the present application. In the embodiments of FIG. 4, one sidelink slot includes 14 OFDM symbols in total, i.e., OFDM symbol #0 to OFDM symbol #13.

According to the embodiments of FIG. 4, the sidelink slot as illustrated by FIG. 4 includes five sidelink sub-slots in total, i.e., SS #0, SS #1, SS #2, SS #3, and SS #4. All of SS #0, SS #1, SS #2, and SS #3 are the same as SS #0, SS #1, SS #2, and SS #3 in FIG. 3, respectively. The difference between FIG. 3 and FIG. 4 is that in the embodiments of FIG. 4, SS #4 belongs to sub-slot type SS_{A3}, which includes one HS₁, one FS₁, and one CS₂.

The sidelink sub-slot patterns (also referred to as sub-slot patterns) in FIGS. 3 and 4 are only for illustrative purpose. It is contemplated that the sub-slot patterns may be other patterns according to some other embodiments of the present application, and that one slot may include other numbers of sub-slots.

For sidelink transmission, resource allocation may be implemented by two modes, i.e., resource allocation mode 1 and resource allocation mode 2.

In the case of resource allocation mode 1, a sidelink transmission (e.g., a PSSCH transmission and/or a PSCCH transmission) can only be carried out by a UE if the UE has been provided with a valid scheduling grant that indicates the exact set of resources used for the sidelink transmission. Assuming that both slot level resource allocation (i.e., resource allocation for slot-based or slot level sidelink transmission) and sub-slot level resource allocation (i.e., resource allocation for sub-slot based or sub-slot level sidelink transmission) are configured in one resource pool (RP), dynamic grant implies that the scheduling grant can be made in different time intervals, i.e., either slot or sub-slot.

In the case of resource allocation mode 2, a decision on sidelink transmission, including decision on the exact set of resources to be used for the sidelink transmission, is made by the transmitting UE (also referred to as Tx UE) based on a sensing-based resource (re-) selection procedure. Resource allocation mode 2 is applicable to both in-coverage and out-of-coverage deployment scenarios.

In the case of coexistence of slot level SL transmission (also referred to as slot level transmission) and sub-slot level SL transmission (also referred to as sub-slot level transmission) within the same RP, resources spanning one SL slot may be fully or partially reserved by one or more sub-slot level SL transmissions.

In such cases, if the slot level SL transmission occupies the slot regardless of possible sub-slot level SL transmission(s), the successful reception probabilities of both the slot level SL transmission and the sub-slot level SL transmission(s) will be decreased due to mutual interference. However, on the other hand, if the slot level SL transmission frees the slot which is partially reserved by one or more sub-slot level SL transmissions, the available resources for the slot level SL transmission will be limited and thus the opportunities for the slot level SL transmission will be reduced. Given the above, how to do slot level SL resource selection for a UE so as to achieve a balance between low resource collision and high spectrum efficiency when slot level SL transmission and sub-slot level SL transmission coexist in the same resource pool needs to be addressed.

Embodiments of the present application provide improved solutions for resource selection in SL communication, which provide several methods for a UE to select slot level SL resources in resource allocation mode 2, thereby achieving a balance between low resource collision and high spectrum efficiency when slot level SL transmission and sub-slot level transmission coexist in the same resource pool. More details on embodiments of the present application will be illustrated in the following text in combination with the appended drawings.

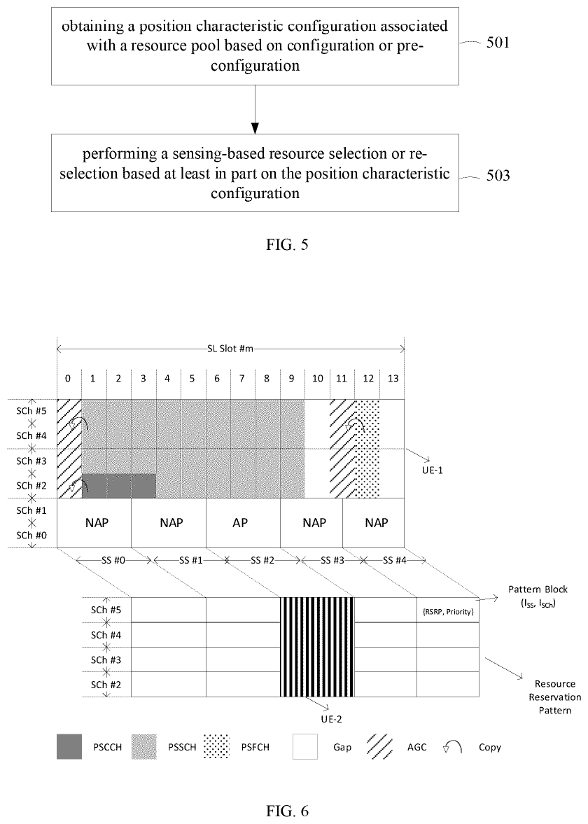

FIG. 5 illustrates a flowchart of an exemplary method for resource selection according to some embodiments of the present application. Embodiments of FIG. 5 provide resource selection methods for resource allocation mode 2. The method illustrated in FIG. 5 may be performed by a UE (e.g., UE 101a or UE 101b in FIG. 1) or other apparatus with the like functions. In the embodiments of FIG. 5, the UE may perform a slot level SL transmission, and thus may also be referred to as a slot level UE.

As shown in FIG. 5, in step 501, the UE may obtain a position characteristic configuration associated with a resource pool based on configuration or pre-configuration. The position characteristic configuration may include a set of position characteristics, and each position characteristic indicates an availability level of a position in an SL slot for simultaneous sub-slot level transmission and slot level transmission. In other words, the position characteristic is determined by considering a mutual impact between a slot level transmission and a sub-slot level transmission on the corresponding position. In some embodiments of the present application, a position may be represented by a symbol within the SL slot or a sub-slot within the SL slot. In some embodiments of the present application, the set of position characteristics may include position characteristics for all the symbols included in the SL slot or include position characteristics for all the sub-slots included in the SL slot.

In some embodiments of the present application, obtaining the position characteristic configuration based on configuration (i.e., the position characteristic configuration is configured) may refer to that: the position characteristic configuration is transmitted by a BS (e.g., BS 102 as shown in FIG. 1) to the UE via a signaling, e.g., a system information block (SIB), a master information block (MIB), a radio resource control (RRC) signaling, a medium access control (MAC) layer control element (CE), or downlink control information (DCI), such that the UE may receive the position characteristic configuration from the BS. In an embodiment of the present application, obtaining the position characteristic configuration based on configuration may apply to the scenario where the UE is in coverage of a network.

In some other embodiments of the present application, obtaining the position characteristic configuration based on pre-configuration (i.e., the position characteristic configuration is pre-configured) may refer to that: the position characteristic configuration may be hard-wired into the UE or stored on a subscriber identity module (SIM) or universal subscriber identity module (USIM) card for the UE, such that the UE may obtain the position characteristic configuration within the UE. In an embodiment of the present application, obtaining the position characteristic configuration based on pre-configuration may apply to the scenario where the UE is out of coverage of the network.

In some embodiments of the present application, the position characteristic configuration may be configured or pre-configured along with a slot pattern configuration per RP. For example, the resource pool configuration for each RP may include a slot pattern configuration (e.g., indicating a slot pattern (a) or a slot pattern (b) as shown in FIG. 2) and the position characteristic configuration, and the resource pool configuration may be obtained based on configuration or pre-configuration as stated above.

In some other embodiments of the present application, the position characteristic configuration may be configured or pre-configured along with a sub-slot pattern configuration per RP. For example, the resource pool configuration for each RP may include a sub-slot pattern configuration (e.g., indicating a sub-slot pattern as shown in FIG. 3 or FIG. 4) and the position characteristic configuration, and the resource pool configuration may be obtained based on configuration or pre-configuration as stated above.

In some embodiments of the present application, the availability levels of positions may be categorized into the following two classes:
AP which means that the position is available for sub-slot level transmission without affecting a slot level transmission in the SL slot; and
NAP which means that the position is not available for sub-slot level transmission without affecting a slot level transmission in the SL slot.

Here, “a position available for sub-slot level transmission without affecting a slot level transmission in the SL slot” means that resource collision between the sub-slot level transmission and the slot level transmission can be avoided or reduced by some means when the position is reserved for the sub-slot level transmission. In such embodiments, the availability level of a position indicated by the position characteristic for the position may be AP or NAP. Consequently, after obtaining the position characteristic, the UE may know whether the position is an AP or a NAP. For example, an AP may be indicated by a position characteristic value of “0” and a NAP may be indicated by a position characteristic value of “1”.

In some other embodiments of the present application, the availability level of a position may be indicated by one of a plurality of integers. Each of the plurality of integers may correspond to a different availability level of a position for sub-slot level transmission by considering the affecting level for a slot level transmission caused by the sub-slot level transmission. Consequently, after obtaining the position characteristic for the position, the UE may know the availability level of the position.

For example, the availability level of a position may be indicated by one of “0”, “1”, “2”, and “3”. The availability level of the position being “0” represents that a sub-slot level transmission for which the position will be reserved may cause the lowest level of impact (or no impact) on a slot level transmission in the SL slot; the availability level of the position being “1” represents that a sub-slot level transmission for which the position will be reserved may cause the second lowest level of impact on a slot level transmission in the SL slot; the availability level of the position being “2” represents that a sub-slot level transmission for which the position will be reserved may cause the second highest level of impact on a slot level transmission in the SL slot; and the availability level of the position being “3” represents that a sub-slot level transmission for which the position will be reserved may cause the highest level of impact on a slot level transmission in the SL slot. Although the above example illustrates four availability levels, it is contemplated that any number of availability levels may be defined in some other embodiments of the present application.

In some embodiments, different symbols or sub-slots within an SL slot may have different impacts on a successful transmission and/or reception of slot level SL transmission on the corresponding symbols or sub-slots due to their variety of functions in the slot level SL transmission.

For example, the first several symbol(s) (e.g., symbols #0 to #3 as shown in FIG. 2) or sub-slot(s) (e.g., sub-slot(s) including at least part of symbols #0 to #3 as shown in FIG. 2) in an SL slot may be used to carry both 1^{st} stage sidelink control information (SCI) and 2^{nd} stage SCI which dominate the successful transmission and/or reception of a slot level SL transmission. Thus, the first several symbol(s) or sub-slot(s) may be indicated as NAP(s) by the corresponding position characteristic(s).

The last several symbol(s) (e.g., symbols #11 and #12 as shown in slot pattern (b) in FIG. 2) or sub-slot(s) (e.g., sub-slot(s) including at least part of symbols #11 and #12 as shown in FIG. 2) in an SL slot may be used to carry PSFCH transmission if PSFCH is configured. The PSFCH transmission may be used to transmit feedback information which may affect retransmission of slot level transmission(s). Thus, the last several symbol(s) or sub-slot(s) may be indicated as NAP(s) by the corresponding position characteristic(s).

The remaining symbol(s) (e.g., symbols #4 to #9 as shown in slot pattern (b) in FIG. 2) or sub-slot(s) may be used to carry PSSCH transmission of a slot level SL transmission, and the impact on the slot level SL transmission caused by sub-slot level SL transmission(s) on such symbol(s) or sub-slot(s) can be reduced by some means such as at least one of the flowing technologies: (1) puncturing slot level SL transmission on the symbol(s) or sub-slot(s) reserved for the sub-slot level SL transmission(s) and/or applying codebook group (CBG) based transmission for the slot level SL transmission; or (2) performing rate-matching on the symbols or sub-slots for the slot level SL transmission other than the symbols or sub-slots reserved for the sub-slot level SL transmission. Consequently, such symbol(s) or sub-slot(s) may be indicated as AP(s) by the corresponding position characteristic(s).

As shown in FIG. 5, after obtaining the position characteristic configuration, in step 503, the UE may perform a sensing-based resource selection or re-selection based at least in part on the position characteristic configuration. For example, when the UE selects resource(s) for a slot level SL transmission within a selection window based on sensing result(s) obtained in a sensing window, the UE may take into account the position characteristic configuration, e.g., by not excluding resource(s) reserved for a sub-slot level SL transmission of another UE on position(s) indicated by the position characteristic configuration as AP(s).

According to some embodiments of the present application, the UE may determine a resource reservation pattern for a slot level candidate resource in the selection window. The resource reservation pattern may indicate an occupancy status within the slot level candidate resource reserved by sub-slot level candidate resource(s) for sidelink transmission(s) to be performed by other UE(s). For example, the resource reservation pattern may be determined based on the sensing result(s) obtained in the sensing window. The resource reservation pattern may also be used for performing the sensing-based resource selection or re-selection by the UE.

A slot level candidate resource may refer to a group of contiguous sub-channels within an SL slot where an SCI and a corresponding transport block (TB) are to be transmitted for a slot level SL transmission. Accordingly, a slot level candidate resource may include one SL slot in the time domain and a number of contiguous sub-channels in the frequency domain, wherein the number of sub-channels in the slot level candidate resource is determined by the UE according to a TB size of the TB to be transmitted.

A sub-slot level candidate resource may refer to a group of contiguous sub-channels within a sub-slot where an SCI and a corresponding TB are to be transmitted for a sub-slot level SL transmission.

Each slot level candidate resource may be organized into PBs. In other words, a slot level candidate resource may include a plurality of PBs, wherein each PB occupies one sub-slot in the time domain and one sub-channel in the frequency domain within the slot level candidate resource. Accordingly, each PB can be labelled by an index of sub-slot (e.g., I_{SS}) and an index of sub-channel (e.g., I_{SCh}). A PB may also be referred to as a pattern unit, a block, a unit, or the like.

A resource reservation pattern for a slot level candidate resource may include a plurality of sets of information associated with the plurality of PBs in the slot level candidate resource, wherein each set of information may be associated with a PB of the plurality of PBs.

In some embodiments of the present application, the set of information associated with a PB may include an RSRP value associated with the PB. The RSRP value may be determined based on measurement(s) on resource(s) (also referred to as “measured resource(s)” hereinafter) associated with the resource(s) containing the PB and reserved for sub-slot level transmission. For example, the measured resource(s) may be used to transmit one of:
a TB associated with an SCI announcing the reserved resource(s) containing the PB;
an SL indicator (SL-I) indicating the reserved resource(s) containing the PB; or
a reference signal (RS) associated with the reserved resource(s) containing the PB.

In an embodiment of the present application, the RSRP associated with each PB can be defined as the linear average over the power contributions (e.g., in [W]) of the resource units (e.g., a resource element (RE), a physical resource block (PRB) and so on) that carry data or signal (e.g., TB, SL-I, RS) within the measured resources. The type of data or signal (e.g., TB, SL-I, RS) to be measured may also be configured or pre-configured to the UE.

Alternatively or additionally, the set of information associated with a PB may include a priority associated with an intended sub-slot level transmission on the reserved resource(s) containing the PB for sub-slot level transmission. The priority may be represented by a priority value as specified in 3GPP standard documents, wherein a lower priority value may correspond to a higher priority level.

FIG. 6 illustrates an exemplary resource reservation pattern for a slot level candidate resource according to some embodiments of the present application.

Referring to FIG. 6, UE-1 may determine a resource reservation pattern for a slot level candidate resource which includes one slot (e.g., slot #m) in the time domain and four consecutive sub-channels (e.g., SCh #2 to SCh #5) in the frequency domain. In the embodiments of FIG. 6, one slot may include 14 OFDM symbols in total, i.e., OFDM symbol #0 to OFDM symbol #13. Although a specific number of OFDM symbols in one sidelink slot are depicted in FIG. 6, it is contemplated that any number of OFDM symbols as specified in 3GPP standards may be included in one sidelink slot.

Slot #m may have a slot pattern (b) as shown in FIG. 2 for a slot level SL transmission of UE-1. In addition, slot #m may include five sub-slots numbered as SS #0 to SS #4. As stated above, SS #0 (including symbols #0 to #2) and SS #1 (including symbol #3) may include both 1^{st} stage SCI and 2^{nd} stage SCI which dominate the successful transmission and/or reception of a slot level SL transmission, and thus SS #0 and SS #1 may be indicated as NAPs by the corresponding position characteristics. SS #3 (including a half of symbol #11) and SS #4 (including symbols #12 and a half of symbol #11) may be used to carry PSFCH transmission, and thus SS #3 and SS #4 may be indicated as NAPs by the corresponding position characteristic(s). SS #2 may be used to carry PSSCH transmission of the slot level SL transmission, and thus may be indicated as an AP by the corresponding position characteristic.

The slot level candidate resource may include 20 PBs, and each PB may be labelled by an index of sub-slot (e.g., I_{SS}) and an index of sub-channel (e.g., I_{SCh}). Accordingly, the resource reservation pattern for the slot level candidate resource may include up to 20 sets of information, where each set of information is associated with a PB and may include an RSRP value and a priority associated with the PB. The resource reservation pattern may be determined based on sensing results of UE-1.

For example, UE-1 may sense an SL-I in a PRB of slot #m-1 to indicate that SS #2 in the time domain and SCh #2 to SCh #5 in the frequency domain of slot #m (hereinafter referred to as reserved resources) are reserved for a sub-slot level SL transmission from UE-2. The reserved resources include 4 PBs, labelled as (2, 2), (2,3), (2, 4), and (2, 5), respectively. Then, UE-1 may determine a set of information including an RSRP value and a priority associated with every PB of the 4 PBs. For example, the RSRP value associated with PB (2, 2) may be determined based on measurement(s) on the PRB for transmitting the SL-I, and the priority associated with PB (2, 2) is the priority of the sub-slot level SL transmission from UE-2. The RSRP value and priority associated with each of PBs (2, 3), (2, 4), and (2, 5) may be determined based on the same methods as those for PB (2, 2).

In some embodiments, for other PBs in the slot level candidate resource which are not reserved for any sub-slot level SL transmission, UE-1 may determine a pre-defined RSRP value and a pre-defined priority for them. For example, the pre-defined RSRP value may be lower than any RSRP value associated with a reserved PB, and the pre-defined priority level may be lower than any priority level associated with a reserved PB. In some other embodiments, UE-1 may not determine an RSRP value or a priority for PBs which are not reserved for any sub-slot level SL transmission.

According to some other embodiments of the present application, the UE may obtain configuration information for the resource reservation pattern based on configuration or pre-configuration. The configuration information may include at least one of: a principle for calculating an AW value for each PB of the slot level candidate resource; or an AW threshold for each PB of the slot level candidate resource.

In some embodiments of the present application, the principle indicates that the AW value for each PB is calculated based on at least one of:
a position characteristic of the PB which is determined based on position characteristic(s) of the sub-slot, to which the PB belongs.
an RSRP value associated with the PB; or
a priority associated with the PB.

The principle may indicate how to calculate the AW value for each PB based on the above parameter(s). For example, the principle for calculating the AW value for each PB may define a function or formula for calculating the AW value, wherein at least one of a position characteristic of the PB, an RSRP value associated with the PB and a priority associated with the PB may be used as variable(s) for the function or used as input(s) of the formula. For example, the principle may indicate y=a*x1+b*x2+c*x3, wherein y is the AW value for the PB, a, b, and c are weighting coefficients, and x1, x2, and x3 are in the field of real numbers and represent the position characteristic of the PB, the RSRP value associated with the PB, and the priority associated with the PB, respectively.

In some embodiments of the present application, obtaining the configuration information based on configuration may refer to that: the configuration information is transmitted by a BS (e.g., BS 102 as shown in FIG. 1) to the UE via a signaling, e.g., a SIB, a MIB, an RRC signaling, a MAC CE, or DCI, such that the UE may receive the configuration information from the BS.

In some other embodiments of the present application, obtaining the configuration information based on pre-configuration may refer to that: the configuration information may be hard-wired into the UE or stored on a SIM or USIM card for the UE, such that the UE may obtain the configuration information within the UE.

In some embodiments of the present application, the configuration information may be configured or pre-configured per RP. For example, the resource pool configuration for each RP may include the configuration information.

The UE may determine an AW value for each PB based on the principle indicated in the configuration information. In some embodiments of the present application, a smaller AW value represents a higher possibility of simultaneous and successful slot level and sub-slot level SL transmissions on the PB. In some other embodiments of the present application, a larger AW value represents a higher possibility of simultaneous and successful slot level and sub-slot level SL transmissions on the PB.

After determining the AW value for each PB of a slot level candidate resource, the UE may further determine an AW value for the slot level candidate resource. For example, the AW value for the slot level candidate resource may be a sum of the AW values for all PBs within the slot level candidate resource. In some embodiments of the present application, the AW value may also be used by the UE for performing a sensing-based resource selection or re-selection in step 503.

According to some embodiments of the present application, performing a sensing-based resource selection or re-selection may include selecting at least one slot level candidate resource in an SW.

In some embodiments of the present application, the at least one slot level candidate resource may be selected from a plurality of slot level candidate resources in the SW. The plurality of slot level candidate resources may be determined based on a TB size of a TB to be transmitted. For example, it is assumed that: the SW includes 5 slots in the time domain, which are numbered as slot #m, slot #m+1, slot #m+2, slot #m+3, and slot #m+4; each slot includes 6 sub-channels numbered as SCh #0 to SCh #5; the TB to be transmitted requires 4 sub-channels in the frequency domain and one slot in the time domain. Then, for each slot, the UE may determine 3 slot level candidate resources. Taking slot #m as an example, the 3 slot level candidate resources are (1) SCh #0 to SCh #3 in the frequency domain and slot #m in the time domain (i.e., slot level candidate resource #1), (2) SCh #1 to SCh #4 in the frequency domain and slot #m in the time domain (i.e., slot level candidate resource #2), and (3) SCh #2 to SCh #5 in the frequency domain and slot #m in the time domain (i.e., slot level candidate resource #3). Accordingly, the plurality of slot level candidate resources in the SW may include 15 slot level candidate resources numbered as slot level candidate resources #1 to #15.

In some embodiments of the present application, in the case that only slot level SL transmission is permitted in the RP, the at least one slot level candidate resource may be selected based on at least one of the following principles:
prioritizing slot level candidate resource(s) not reserved by other UE(s);
prioritizing slot level candidate resource(s) reserved for slot level transmission(s) associated with lower RSRP value(s);
prioritizing slot level candidate resource(s) reserved for slot level transmission(s) associated with lower priority level(s); and
guaranteeing that the selected slot level candidate resource(s) are of at least 20% of the plurality of slot level candidate resources within the SW.

Alternatively or additionally, in the case that slot level SL transmission and sub-slot level SL transmission may coexist in the same RP, the at least one slot level candidate resource may be selected based on at least one of the following principles:
prioritizing slot level candidate resource(s) including resource(s) reserved for sub-slot level transmission(s) on AP(s) (hereinafter referred to as principle #1);
prioritizing slot level candidate resource(s) including resource(s) reserved for sub-slot level transmission(s) associated with lower RSRP value(s) (hereinafter referred to as principle #2); or
prioritizing slot level candidate resource(s) including resource(s) reserved for sub-slot level transmission(s) associated with lower priority level(s) (hereinafter referred to as principle #3).

For example, principle #1 may be implemented as follows: according to the sensing result obtained in a sensing window and the position characteristic configuration, the UE may determine that a number of slot level candidate resources include resource(s) reserved for sub-slot level transmission(s) on AP(s) and do not include resource(s) reserved for sub-slot level transmission(s) on NAP(s). Then, the UE may preferentially select the number of slot level candidate resources or exclude the slot level candidate resource(s) including resource(s) reserved for sub-slot level transmission(s) on NAP(s).

For example, principle #2 may be implemented as follows: according to the sensing result obtained in a sensing window, for each slot level candidate resource including resource(s) reserved for sub-slot level transmission(s), the UE may determine an RSRP value associated with the slot level candidate resource based on an RSRP value associated with the sub-slot level transmission(s). Then, the UE may order the slot level candidate resources in an ascending order or descending order of the RSRP values, and preferentially select slot level candidate resources associated with lower RSRP values. The aim of principle #2 is to reduce the impact of any collision due to the use of the same resource for slot level and sub-slot level sidelink transmissions by nearby UEs while allowing spatial reuse of the resources by UEs at larger distance.

For example, principle #3 may be implemented by one of the following manners. The aim of principle #3 is to prioritize resources for which a collision may be less critical.

In an embodiment, according to the sensing result obtained in a sensing window, for each slot level candidate resource including resource(s) reserved for sub-slot level transmission(s), the UE may determine a priority level associated with the slot level candidate resource based on a priority level associated with the sub-slot level transmission(s). Then, the UE may order the slot level candidate resources in an ascending order or descending order of the priority levels, and preferentially select slot level candidate resources associated with lower priority levels. The number of slot level candidate resources selected by the UE according to principle #3 may be based on the UE's implementation. In such embodiment, selecting slot level candidate resources associated with lower priority levels may refer to selecting slot level candidate resources associated with higher priority values as specified in 3GPP standard documents.

In another embodiment, prioritizing slot level candidate resource(s) including resource(s) reserved for sub-slot level transmission(s) associated with lower priority level(s) may refer to prioritizing slot level candidate resource(s) including resource(s) reserved for sub-slot level transmission(s) associated with lower relative priority(ies).

In some cases, the UE may obtain a priority threshold based on configuration and pre-configuration. In addition, according to the sensing result obtained in a sensing window, for each slot level candidate resource including resource(s) reserved for sub-slot level transmission(s), the UE may determine a priority value associated with the slot level candidate resource based on a priority value associated with the sub-slot level transmission(s). Then, the UE may determine a relative priority for the slot level candidate resource by subtracting the priority value from the priority threshold. Then, the UE may order the slot level candidate resources in an ascending order or descending order of the relative priorities, and preferentially select slot level candidate resources associated with lower relative priorities. For example, it is assumed that the priority threshold is 3 and the priority values associated with 3 slot level candidate resources are 1, 2, and 3, respectively, then the relative priorities are 2, 1, and 0, respectively, and the UE may preferentially select the slot level candidate resource associated with the relative priority of 0 (i.e., associated with the priority value of 3).

In some other cases, the UE may not obtain a priority threshold based on configuration and pre-configuration. In such cases, the UE may determine a priority value associated with the slot level SL transmission intended by the UE. In addition, according to the sensing result obtained in the sensing window, for each slot level candidate resource including resource(s) reserved for sub-slot level transmission(s), the UE may determine a priority value associated with the slot level candidate resource based on a priority value associated with the sub-slot level transmission(s). Then, the UE may determine a relative priority for the slot level candidate resource by subtracting the priority value associated with the slot level candidate resource from the priority value associated with the intended slot level SL transmission. Then, the UE may order the slot level candidate resources in an ascending order or descending order of the relative priorities, and preferentially select slot level candidate resources associated with lower relative priorities.

The UE may apply principle #1, principle #2, and principle #3 in any order or in any combination. In an embodiment, the UE may select the at least one slot level candidate resource based on an order of principle #1, principle #2, and principle #3. For example, the UE may first use principle #1 to select the candidate resources. In the case that the selected candidate resources are enough, the UE may not perform principle #2 and principle #3; otherwise, the UE may perform principle #2 and principle #3 in sequence until enough candidate resources (e.g., the selected slot level candidate resources are of at least 20% of the plurality of slot level candidate resources within the SW) are selected.

In some other embodiments of the present application, the at least one slot level candidate resource may be selected based on one of the following principles:
selecting slot level candidate resource(s) with AW value(s) higher than an AW threshold for the slot level candidate resource(s) (hereinafter referred to as principle #4);
selecting slot level candidate resource(s) with AW value(s) lower than the AW threshold for the slot level candidate resource(s) (hereinafter referred to as principle #5);
selecting slot level candidate resource(s) according to an increasing order of AW values for all slot level candidate resources determined in the SW (hereinafter referred to as principle #6); or
selecting slot level candidate resource(s) according to a decreasing order of AW values for all slot level candidate resources determined in the SW (hereinafter referred to as principle #7).

In some embodiments, an AW value for a slot level candidate resource is a sum of AW values for all PBs within the slot level candidate resource, and an AW threshold for a slot level candidate resource equals an AW threshold for each PB multiplied by a number of PBs within the slot level candidate resource. As stated above, the AW threshold for each PB may be obtained from the configuration information for the resource reservation pattern. Since the plurality of slot level candidate resources determined in the SW includes the same number of PBs, the AW thresholds for the plurality of slot level candidate resources are the same.

In principle #4, a higher AW value represents a higher possibility of simultaneous and successful slot level SL transmission and sub-slot level SL transmission on the same slot level resource. For each slot level candidate resource, the UE may calculate an AW value. Then, the UE may select the slot level candidate resource(s) with AW value(s) higher than the AW threshold.

In principle #5, a smaller AW value represents a higher possibility of simultaneous and successful slot level SL transmission and sub-slot level SL transmission on the same slot level resource. Accordingly, the UE may select the slot level candidate resource(s) with AW value(s) lower than the AW threshold.

In principle #6, a smaller AW value represents a higher possibility of simultaneous and successful slot level SL transmission and sub-slot level SL transmission on the same slot level resource. For each slot level candidate resource, the UE may calculate an AW value. Then, the UE may order the slot level candidate resources according to an increasing order of the AW values, and may select a number of slot level candidate resources with smaller AW values (e.g., the first several slot level candidate resources).

In principle #7, a larger AW value represents a higher possibility of simultaneous and successful slot level SL transmission and sub-slot level SL transmission on the same slot level resource. For each slot level candidate resource, the UE may calculate an AW value. Then, the UE may order the slot level candidate resources according to a decreasing order of the AW values, and may select a number of slot level candidate resources with larger AW values (e.g., the first several slot level candidate resources).

In some embodiments of the present application, after selecting the at least one slot level candidate resource, the UE may further select a set of resources from the at least one slot level candidate resource from the layer 2′s perspective. Then, the UE may perform a random selection to select one candidate resource from the set of resources to further reduce resource collision among selection results from multiple UEs.

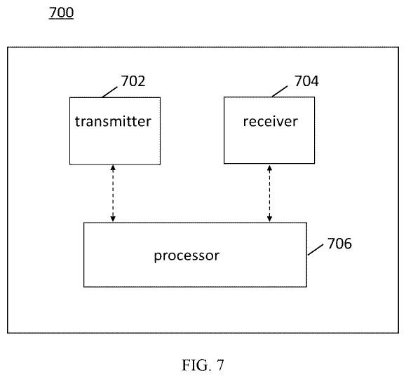

FIG. 7 illustrates a simplified block diagram of an exemplary apparatus 700 for resource selection according to some embodiments of the present application. In some embodiments, the apparatus 700 may be or include at least part of a UE (e.g., UE 101a or UE 101b in FIG. 1). In some other embodiments, the apparatus 700 may be or include at least part of a BS (e.g., BS 102 in FIG. 1).

Referring to FIG. 7, the apparatus 700 may include at least one transmitter 702, at least one receiver 704, and at least one processor 706. The at least one transmitter 702 is coupled to the at least one processor 706, and the at least one receiver 704 is coupled to the at least one processor 706.

Although in this figure, elements such as the transmitter 702, the receiver 704, and the processor 706 are illustrated in the singular, the plural is contemplated unless a limitation to the singular is explicitly stated. In some embodiments of the present application, the transmitter 702 and the receiver 704 may be combined to one device, such as a transceiver. In some embodiments of the present application, the apparatus 700 may further include an input device, a memory, and/or other components. The transmitter 702, the receiver 704, and the processor 706 may be configured to perform any of the methods described herein (e.g., the method described with respect to FIG. 5).

According to some embodiments of the present application, the apparatus 700 may be a UE, and the transmitter 702, the receiver 704, and the processor 706 may be configured to perform operations of the method as described with respect to FIGS. 5 and 6. For example, the processor 706 may be configured to: obtain a position characteristic configuration associated with a resource pool based on configuration or pre-configuration, wherein the position characteristic configuration includes a set of position characteristics, and each position characteristic indicates an availability level of a position in an SL slot for simultaneous sub-slot level transmission and slot level transmission; and perform a sensing-based resource selection or re-selection based at least in part on the position characteristic configuration. In some embodiments, the processor 706 is further configured to determine a resource reservation pattern of a slot level candidate resource including a plurality of PBs. In some embodiments, the processor 706 is further configured to obtain configuration information for the resource reservation pattern.

According to some embodiments of the present application, the apparatus 700 may be a BS. The transmitter 702 may be configured to transmit a position characteristic configuration associated with a resource pool, wherein the position characteristic configuration includes a set of position characteristics, and each position characteristic indicates an availability level of a position in an SL slot for simultaneous sub-slot level transmission and slot level transmission. In some embodiments, the transmitter 702 is further configured to transmit configuration information for a resource reservation pattern of a slot level candidate resource including a plurality of PBs.

In some embodiments of the present application, the apparatus 700 may further include at least one non-transitory computer-readable medium. In some embodiments of the present disclosure, the non-transitory computer-readable medium may have stored thereon computer-executable instructions to cause the processor 706 to implement any of the methods as described above. For example, the computer-executable instructions, when executed, may cause the processor 706 to interact with the transmitter 702 and/or the receiver 704, so as to perform operations of the methods, e.g., as described with respect to FIGS. 5 and 6.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for resource selection for SL communication, including a processor and a memory. Computer programmable instructions for implementing a method for resource selection for SL communication are stored in the memory, and the processor is configured to perform the computer programmable instructions to implement the method for resource selection for SL communication. The method for resource selection for SL communication may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for resource selection for SL communication according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
obtain a position characteristic configuration associated with a resource pool based on configuration or pre-configuration, wherein the position characteristic configuration includes a set of position characteristics, and each position characteristic indicates an availability level of a position in a sidelink (SL) slot for simultaneous sub-slot level transmission and slot level transmission; and
perform a sensing-based resource selection or re-selection based at least in part on the position characteristic configuration.

2. The UE of claim 1, wherein the position characteristic configuration is configured or pre-configured along with a slot pattern configuration or a sub-slot pattern configuration per resource pool.

3. The UE of claim 1, wherein the position is represented by a symbol within the SL slot or a sub-slot within the SL slot.

4. The UE of claim 1, wherein the availability level of the position is indicated as one of the following:
an available position (AP) that indicates the position is available for sub-slot level transmission without affecting a slot level transmission in the SL slot; or
a non-available position (NAP) that indicates the position is not available for sub-slot level transmission without affecting a slot level transmission in the SL slot.

5. The UE of claim 1, wherein the availability level of the position is indicated as one of a plurality of integers.

6. The UE of claim 1, wherein the at least one processor is further configured to cause the UE to: determine a resource reservation pattern of a slot level candidate resource including a plurality of pattern blocks (PBs), and wherein each PB occupies one sub-slot of the slot level candidate resource and one sub-channel of the slot level candidate resource.

7. The UE of claim 6, wherein the resource reservation pattern includes a plurality of sets of information associated with the plurality of PBs, wherein each set of information is associated with a PB of the plurality of PBs and includes at least one of:
a reference signal received power (RSRP) value associated with the PB, which is determined based on measurements on resources associated with reserved resources containing the PB for sub-slot level transmission; or
a priority associated with an intended sub-slot level transmission on the reserved resources containing the PB for sub-slot level transmission.

8. The UE of claim 6, wherein the at least one processor is further configured to cause the UE to: obtain configuration information for the resource reservation pattern, and wherein the configuration information includes at least one of:
a principle for calculating an available weight (AW) value for each PB of the slot level candidate resource; or
an AW threshold for each PB of the slot level candidate resource.

9. The UE of claim 8, wherein the principle indicates that the AW value for each PB is calculated based on at least one of:
a position characteristic of the PB which is determined based on position characteristics of positions in the PB;
an RSRP value associated with the PB; or
a priority associated with the PB.

10. The UE of claim 1, wherein to perform the sensing-based resource selection or re-selection, the at least one processor is further configured to cause the UE to: select at least one slot level candidate resource in a selection window (SW).

11. The UE of claim 10, wherein the at least one slot level candidate resource is selected based on at least one of the following principles:
prioritizing slot level candidate resources including resources reserved for sub-slot level transmissions on available positions;
prioritizing slot level candidate resources including resources reserved for sub-slot level transmissions associated with lower RSRP values; or
prioritizing slot level candidate resources including resources reserved for sub-slot level transmissions associated with lower priority levels.

12. The UE of claim 10, wherein the at least one slot level candidate resource is selected based on one of the following principles:
selecting slot level candidate resources with AW values higher than an AW threshold for the slot level candidate resources;
selecting slot level candidate resources with AW values lower than the AW threshold for the slot level candidate resources;
selecting slot level candidate resources according to an increasing order of AW values for all slot level candidate resources determined in the SW; or
selecting slot level candidate resources according to a decreasing order of AW values for all slot level candidate resources determined in the SW.

13. The UE of claim 10, wherein an AW value for a slot level candidate resource is a sum of AW values for all PBs within the slot level candidate resource, and the AW threshold for the slot level candidate resources equals an AW threshold for each PB multiplied by a number of PBs within each slot level candidate resource.

14. A base station (BS) for wireless communication, comprising:
at least one memory; and
at least one processor coupled with the at least one memory and configured to cause the BS to:
transmit a position characteristic configuration associated with a resource pool, wherein the position characteristic configuration includes a set of position characteristics, and each position characteristic indicates an availability level of a position in a sidelink (SL) slot for simultaneous sub-slot level transmission and slot level transmission.

15. A method performed by a user equipment (UE), the method comprising:
obtaining a position characteristic configuration associated with a resource pool based on configuration or pre-configuration, wherein the position characteristic configuration includes a set of position characteristics, and each position characteristic indicates an availability level of a position in a sidelink (SL) slot for simultaneous sub-slot level transmission and slot level transmission; and
performing a sensing-based resource selection or re-selection based at least in part on the position characteristic configuration.

16. A processor for wireless communication, comprising:
at least one controller coupled with at least one memory and configured to cause the processor to:
obtain a position characteristic configuration associated with a resource pool based on configuration or pre-configuration, wherein the position characteristic configuration includes a set of position characteristics, and each position characteristic indicates an availability level of a position in a sidelink (SL) slot for simultaneous sub-slot level transmission and slot level transmission; and
perform a sensing-based resource selection or re-selection based at least in part on the position characteristic configuration.

17. The processor of claim 16, wherein the position characteristic configuration is configured or pre-configured along with a slot pattern configuration or a sub-slot pattern configuration per resource pool.

18. The processor of claim 16, wherein the position is represented by a symbol within the SL slot or a sub-slot within the SL slot.

19. The processor of claim 16, wherein the availability level of the position is indicated as one of the following:
an available position (AP) that indicates the position is available for sub-slot level transmission without affecting a slot level transmission in the SL slot; or
a non-available position (NAP) that indicates the position is not available for sub-slot level transmission without affecting a slot level transmission in the SL slot.

20. The processor of claim 16, wherein the availability level of the position is indicated as one of a plurality of integers.
